(19) United States
(12) Patent Application Publication
(10) Pub. No.: US 2010/0225190 A1
(43) Pub. Date: Sep. 9, 2010

(54) Generator

(76) Inventor: Hang-Chang HUANG, Nantou City (TW)

Correspondence Address: SINORICA, LLC, 2275 Research Blvd., Suite 500, ROCKVILLE, MD, 20850, US

(21) Appl. No.: 12/400,032

(22) Filed: Mar. 9, 2009

(51) Int. Cl. H02K 23/60

(52) U.S. Cl. 310/115

(57) ABSTRACT

A generator includes a body and at least one drive unit. The body includes at lease one winding portion and one magnetic pole portion. The winding portion is formed that is wrapped with windings, while the magnetic pole portion is rounded with a magnetic pole around the circumference of winding portion. Both the winding portion and the magnetic pole portion may run freely. The drive unit drives the winding portion and the magnetic pole portion, making the winding portion and the magnetic pole portion run reversely. Thus, the drive unit may drive the winding portion and the magnetic pole portion run oppositely for heightening the frequency of magnetic pole cutting to increase flux, and then increasing the efficiency of generator.

### BACKGROUND OF THE INVENTION

1. Field of the Invention

This invention relates to a generator.

2. Description of the Prior Art

A conventional generator is made up of a stator and a rotor. When the rotor runs to make windings between the stator and the rotor to be cut by magnetic poles, electric power is outputted.

Consequently, because of the technical defects of described above, the applicant keeps on carving unflaggingly through wholehearted experience and research to develop the present invention, which can effectively improve the defects described above.

### SUMMARY OF THE INVENTION

However, in order to make the conventional generator generate nominal power, the rotor must run at a determined revolving speed. Blades are provided and fixed onto the rotor of the conventional generator, such as a wind driven generator. The wind force is used to turn the blades to make the rotor run, so the generator cannot generate voltage when wind velocity is low during wind power generation, and electric flux is proportional to rotation frequency, rated electric flux is generated only when the revolving speed is high, and is not generated when the revolving speed is extremely low. Besides, the wind is naturally generated, which cannot be controlled, so the generator running to generate power with the wing force cannot spread. Most of the wind power generators are placed at seaside or an open space to receive higher quantity of wind for achievement of wind power generation.

Thus, this invention is to improve the magnetic pole cutting at a higher frequency in the condition of a constant driving source.

A generator according to this invention comprises at least one body and one drive unit. The body comprises at lease one winding portion and one magnetic pole portion. The winding portion is formed that is wrapped with windings, while the magnetic pole portion is rounded with a magnetic pole around the circumference of winding portion. Further, both the winding portion and the magnetic pole portion may run freely. The drive unit drives the winding portion and the magnetic pole portion, making the winding portion and the magnetic pole portion run reversely.

In the generator according to this invention, the magnetic pole portion and the winding portion are driven by the drive unit to run reversely so that the body of generator may run at a comparatively increasing speed, making the generator easily generate power at a rated running speed.

### BRIEF DESCRIPTION OF THE DRAWINGS

FIG. 1 is a 3D view of the appearance of this invention in a preferred embodiment;

FIG. 2 is a sectional view of the preferred embodiment of this invention;

FIG. 3 is a schematic view illustrating the operation in the preferred embodiment of this invention;

FIG. 4 is a view of the appearance of another preferred embodiment of this invention;

FIG. 5 is a view of the appearance of a further preferred embodiment of this invention; and

FIG. 6 is a 3D view of the appearance of a next embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

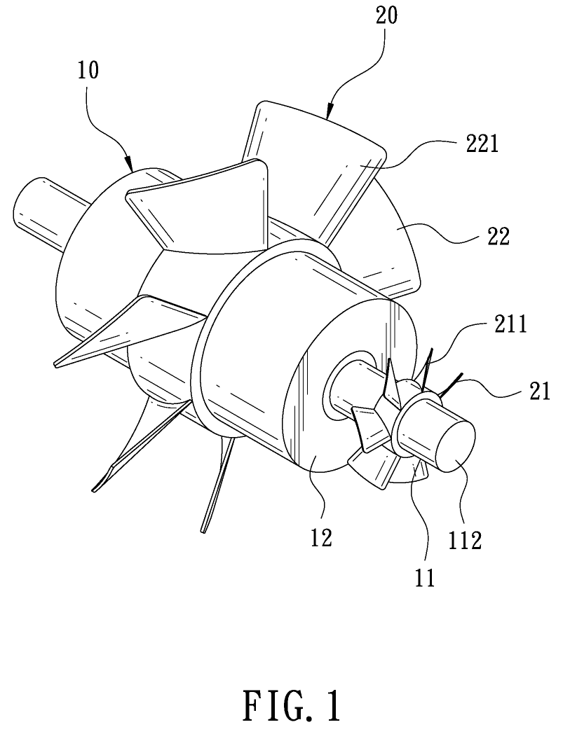

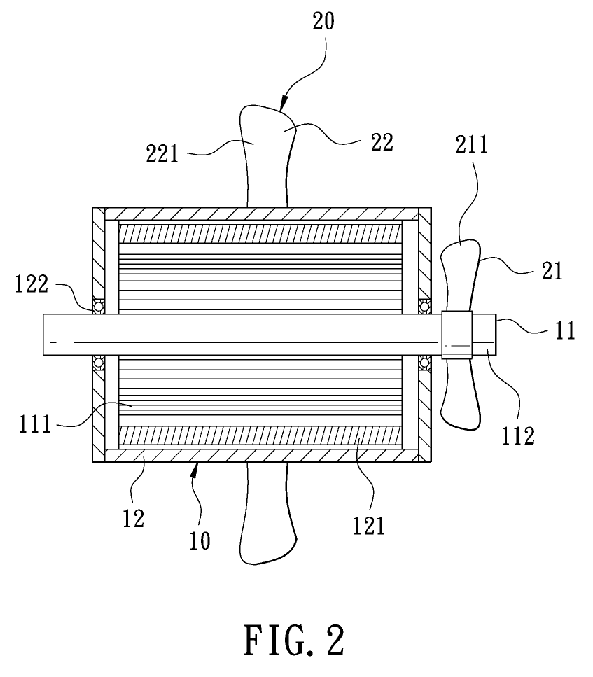

With reference to FIGS. 1 and 2 shown respectively as an appearance view and a sectional view, a generator according to this invention in a preferred embodiment comprises a body 10 and a drive unit 20.

The body 10 comprises a winding portion 11 and a magnetic pole portion 12. The winding portion 11 is formed that is wrapped with windings 111. From two sides of the winding portion 11, two shafts 112 protrude axially.

Several magnetic poles 121 are formed around the inner circumference of magnetic pole portion 12 so that the magnetic poles 121 may be formed around the outer circumference of windings 111 of the winding portion 11. At each of the two sides of magnetic pole portion 12, a single-phase bearing 122 is fixed around onto the shaft 112 of winding portion 11 so that the magnetic pole portion 12 may be pivoted around the outer circumference of winding portion 11. Both the winding portion 12 and the magnetic pole portion 11 may run freely. Further, the position or amount of winding portion 11 and winding pole portion 12 may also be changed or increased depending on requirements.

The drive unit 20 comprises a first drive unit 21 and a second drive unit 22. Each of the first drive unit 21 and second drive unit 22 is structured with several blades 211 and 221. When the blade 211 of first drive unit 21 and the blade 221 of second drive unit 22 are driven to run reversely, the first drive unit 21 is set on the shaft 112 of winding portion 11. Further, the second drive unit 22 is set around the outer circumference of magnetic pole portion 12.

In order to further make apparent the structural features, applied skill and manners, and expected effects according to this invention, what are applied in this invention are in detail described, and it is thus believed that this invention is thoroughly and concretely apparent.

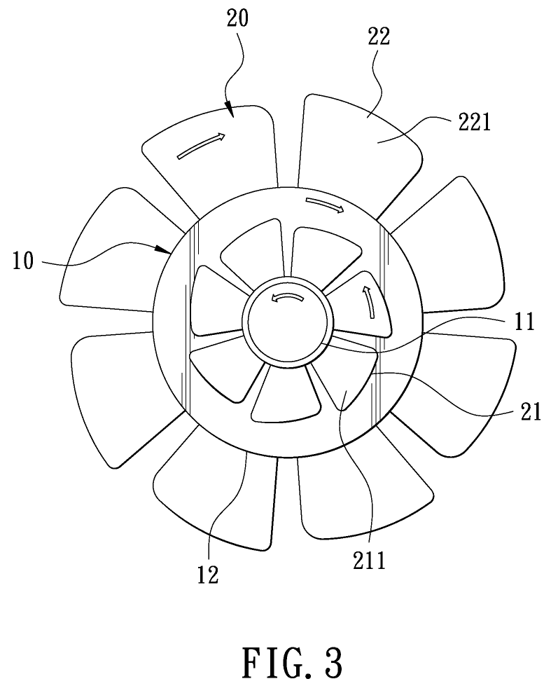

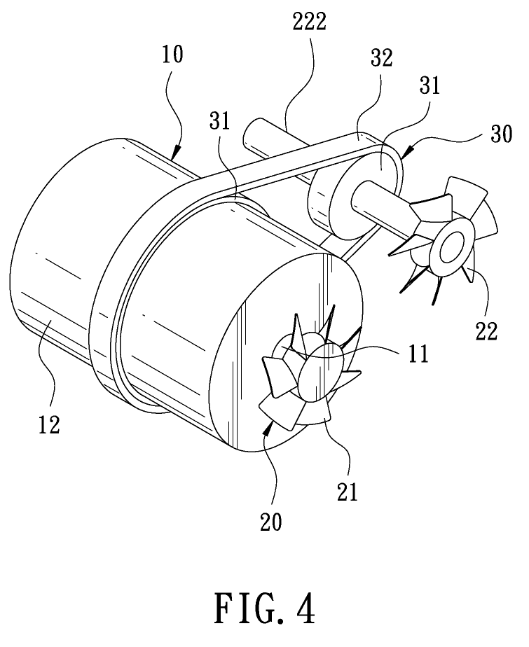

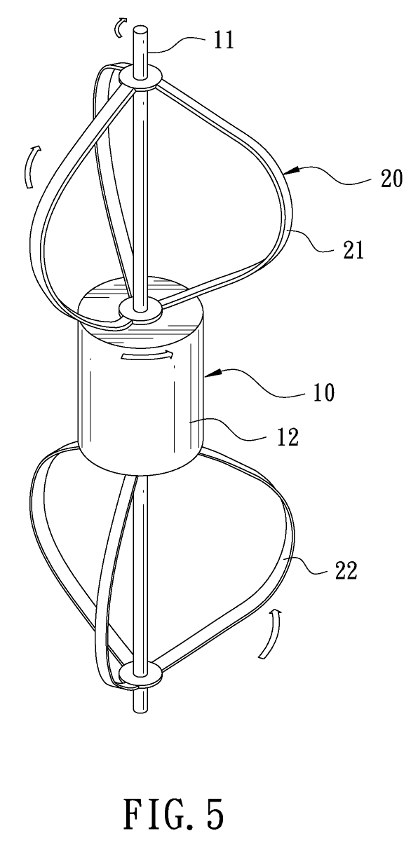

With reference to FIG. 3 shown as a schematic view illustrating the operation of this invention, when the generator runs, wind power or hydraulic power may be used to drive the first drive unit 21 and the second drive unit 22, in which the first drive unit 21 and the second drive unit 22 revolve in different directions. Thus, when the generator is driven by the wind power or hydraulic power, the running frequency of first drive unit 21 running with second drive unit 22 is twice that of a single rotor when running for increase of the revolving speed of body 10 and for achievement of expected revolving speed at which the body 10 generates power. Further, with reference to FIG. 4, the second drive unit 22 and the body 10 are arranged in the same axis. The second drive unit 22 is provided securely with a link shaft 222. A transmission unit 30 is provided between the link shaft 222 and the body 10. The transmission unit 30 comprises two belt pulleys 31 and a belt 32. The belt pulleys 31 are arranged separately on the link shaft 222 and the magnetic pole portion 12. The belt 32 is arranged around the belt pulleys 31. The first drive unit 21 and the second drive unit 22 may synchronously run reversely. On the transmission unit 30, the belt pulley 31 may be replaced with a gear. With reference to FIG. 5, the first drive unit 21 and the second drive unit 22 are separately arranged at the two sides of body 10 and run reversely.

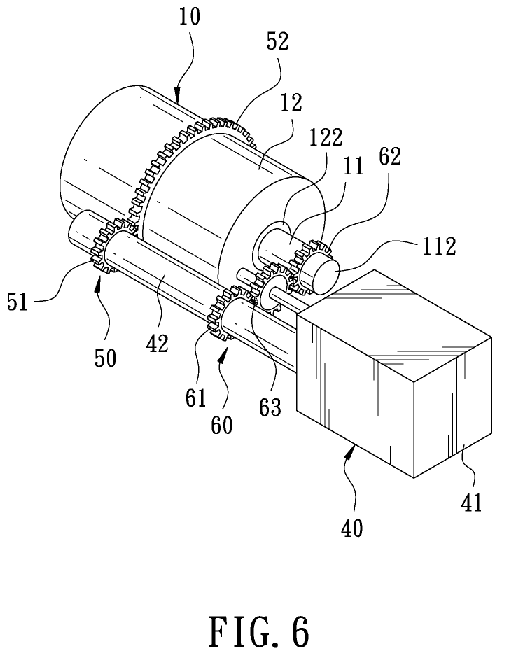

With reference to FIG. 6 illustrating another embodiment of this invention, the main structure is the same as that described in the former embodiment, so unnecessary details are not given here. The drive unit 40 and the body 10 are arranged in the same axis. The drive unit 40 is an internal combustion engine 41. The internal combustion engine 41 is provided in an axial direction with a link shaft 42 that may revolve. A forward transmission unit 50 and a reverse transmission unit 60 are provided between the link shaft 42 and the body. In the forward transmission unit 50, a forward driving gear 51 is arranged around the link shaft 42. Besides, a forward driven gear 52 is arranged securely on the magnetic pole portion 12. The forward driving gear 51 gears with the forward driven gear 52. Next, in the reverse transmission unit 60, a reverse driving gear 61 is arranged around the link shaft 42 and a reverse driven gear 62 is arranged securely on the winding portion 11. A steering gear 63 gears between the reverse driving gear 61 and the reverse driven gear 62. Thus, when the drive unit 40 drives the link shaft 42, the link shaft 42 synchronously drives the forward driving gear 51 and the reverse driving gear 61 and the forward driving gear 51 directly links the forward driven gear 52 to drive the magnetic pole portion 12. Further, the reverse driving gear 61 follows the steering gear 63 to drive the reverse driven gear 62, and then the reverse driven gear 62 drives the winding portion 11. Thus, with the forward driven gear 52 that runs against the reverse driven gear 62 reversely, the winding portion 11 and the magnetic pole portion 12 run reversely. Accordingly, the running speed of drive unit 40 may be decreasingly half for achievement of the determined running frequency and for the requests of energy resource decrease and power generation efficiency increase.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A generator, comprising:
a body, comprising a winding portion and at least a magnetic pole portion, in which the winding portion is formed that is wrapped with windings, the magnetic pole portion is rounded with a magnetic pole around the circumference of winding portion, and both the winding portion and the magnetic pole portion run freely; and
at least one drive unit driving the winding portion and the magnetic pole portion, making the winding portion and the magnetic pole portion run reversely.

2. The generator according to claim 1, wherein a drive unit is provided on the winding portion, the magnetic pole portion is provided with a drive unit, and the drive unit runs reversely.

3. The generator according to claim 2, wherein the drive unit is structured with a blade.

4. The generator according to claim 1, wherein a drive unit is provided on the body, another drive unit is provided outside the body, the drive unit outside the body is connected to the body with a transmission unit, the drive unit connects separately to the winding portion and the magnetic pole portion, and the drive unit runs reversely.

5. The generator according to claim 4, wherein the drive unit is structured with a belt and a belt pulley.

6. The generator according to claim 4, wherein the drive unit is structured with a gear unit.

7. The generator according to claim 1, wherein two transmission units are provided and connected between the drive unit and the body, the transmission units are separately provided on the magnetic pole portion and the winding portion, and the transmission unit drives the magnetic pole portion and the winding portion to run reversely.

8. The generator according to claim 7, wherein the transmission unit comprises a forward transmission unit and a reverse transmission unit.

9. The generator according to claim 8, wherein the forward transmission unit is structured with a forward driving gear and a forward driven gear and the reverse transmission unit is structured with a reverse driving gear, a steering gear, and a reverse driven gear.

10. The generator according to claim 7, wherein the drive unit is an internal combustion engine provided with a link shaft and the transmission units that are in axial to each other.
